(19) United States
(12) Patent Application Publication
(10) Pub. No.: US 2022/0343002 A1
(43) Pub. Date: Oct. 27, 2022

(54) Communication method and device capable of ensuring the security of personal information

(71) Applicant: FLYSHEET INFORMATION SERVICES CO., LTD., Taipei City (TW)

(72) Inventor: Fon-Shiao Chiu, Taipei City (TW)

(21) Appl. No.: 17/495,753

(22) Filed: Oct. 6, 2021

(30) Foreign Application Priority Data
Apr. 22, 2021 (TW) 110114842

(51) Int. Cl. G06F 21/60; G06F 21/62; G06F 21/44; H04M 3/38

(52) U.S. Cl. CPC G06F 21/606; G06F 21/6263; G06F 21/44; H04M 3/382

(57) ABSTRACT

A communication method and device capable of ensuring the security of personal information, wherein the device comprises a database, an information processor and a transceiver; wherein in the database at least one Party B's personal information, including a Party B's code and a Party B's means of communication, is saved, if a Party C (anyone else) wants to communicate the Party B, the Party C can use the said communication device capable of ensuring the security of personal information to forward an information, whereby the security of personal information is guaranteed while the Party C is communicating with the Party B.

### FIELD OF THE INVENTION

The present invention is related to a communication method and device capable of ensuring the security of personal information; particularly to a communication method and device capable of ensuring the security of personal information, wherein the communication between both parties is easy, and at the same time the security of personal information is guaranteed.

### BACKGROUND OF THE INVENTION

Due to the scientific and technological development, people have developed many convenient and highly efficient communication methods and devices. However, occasionally a communication method has to work in certain situations, such as on a car, for a specific person, or in a pet, for contacting an unspecified person. Leaving personal information, like a phone number, can sometimes cause troubles. Situations around parking cars are important examples. According to the statistics of the Ministry of Transportation and communications R.O.C. in December 2020, the number of cars in Taiwan has exceeded 8 million. Various traffic incidents and disputes related to parking are constantly emerging, for example, illegal parking at a house entrance or in a private parking space. Subsequently, conflicts happen and even have to be brought to court due to improper handling methods. Furthermore, recently the number of people having electric vehicles has gradually increased, so many parking lots have electric vehicle charging spaces, but there are many ordinary car drivers who park their cars in electric vehicle charging spaces, which has caused more parking disputes.

Generally, if one is confronted with one of the above situations, the common method to get in touch with the car owner is leaving contact information placed on the windshield of the car. However, this way is fraught with problems: 1) Not every car owner is used to leave contact information on the car due to the awareness of protecting personal information security, thus the car owner may probably not be contacted. 2) When contacting the car owner directly via the phone, the caller may be harassed because it is possible to discriminate the voice of the caller according to gender of other specifics. 3) Avoiding possible conflicts after direct contact may be necessary. 4) Avoiding being misunderstood for chasing a car may be necessary, even if no more than a kind reminder has occurred.

Considering above points, there is an urgent need to solve the above-mentioned problems that are due to conventional method of contacting. Therefore, the inventor has deliberated improvements of conventional methods and devices with the two key points in mind, “personal information protection” and “notification reminder”.

### SUMMARY OF THE INVENTION

The object of the present invention is to provide a communication method capable of ensuring the security of personal information, wherein communication between a Party C and a Party B is easy, and at the same time security of personal information is guaranteed.

The method to achieve of the object mentioned above comprises the following steps: S11: at least one personal information of a Party B is saved in a database of a communication device capable of ensuring the security of personal information; wherein the personal information of the Party B includes a Party B's code and a Party B's means of communication; and the communication device capable of ensuring the security of personal information comprises moreover an information processor coupled with the database and a transceiver coupled with the information processor; S12: a Party C sends an target code and a message, which the Party C wants to notify the Party B, into the said transceiver; S13: the said information processor receives from the transceiver the target code and the message, which the Party C wants to notify the Party B, and searches the database, according to the target code, to find out the Party B's code corresponding to the target code, and furthermore to find out the corresponding personal information of the Party B, thereafter the transceiver sends a message, which the Party C wants to notify the Party B, into the corresponding means communication of the Party B.

The other object of the present invention is to provide a communication method capable of ensuring the security of personal information, wherein communication between the Party C and the Party B is easy, and at the same time security of personal information is guaranteed.

The method to achieve the object mentioned above comprises the following steps:

S21: at least one personal information of a Party B is saved in a database of a communication device capable of ensuring the security of personal information; wherein the personal information of the Party B includes a Party B's code and a Party B's means of communication, wherein the communication device capable of ensuring the security of personal information comprises moreover an information processor coupled with the said database and a transceiver coupled with the said information processor; S22: a Party C sends a target code and a message, which the Party C wants to notify the Party B, into the transceiver, as well as sends a means of communication of the Party C; S23: the information processor receives from the transceiver the target code and the message, which the Party C wants to notify the Party B, and searches the database, according to the target code, to find out the Party B's code corresponding to the target code, and furthermore to find out the corresponding personal information of the Party B, thereafter the transceiver sends the message, which the Party C wants to notify the Party B, into the Party B's means of communication, and moreover sends an message to the Party C.

Preferably, after the step S23 the method comprises furthermore the following steps: S24: having received the message, which the Party C wants to notify the Party B, from the Party C, the corresponding Party B sends a message, which the Party B wants to notify the Party C, into the said transceiver; S25: the said information processor receives from the transceiver the message, which the Party B wants to notify the Party C, thereafter the said transceiver sends the message, which the Party B wants to notify the Party C, into the Party C's means communication.

Preferably, the transceiver sends messages through telephone or the internet, thereby it is convenient for use.

Preferably, the message received and/or sent through the transceiver is/are text and/or voice information, thereby it is convenient for use.

Preferably the Party B's means of communication is/are telephone and/or the internet, thereby it is convenient for use.

Another object of the present invention is to provide a communication device capable of ensuring the security of personal information, wherein communication between a Party C and a Party B is easy, and at the same time security of personal information is guaranteed.

Preferably, the Party B's code is the car plate number of the Party B, thereby it is convenient for the Party C with the car plate number to identify a different Party B quickly.

The device to achieve the object mentioned above comprises: a database, in which more than one personal information of the Party B are saved; wherein the personal information of the Party B includes a Party B's code and a Party B's means of communication; an information processor coupled with the database; and a transceiver coupled with the said information processor for receiving a target code and message, which the Party C wants to notify the Party B, sent from the Party C; wherein the information processor receives from the transceiver the target code and the message notified by the Party C, and moreover searches the database, according the target code, to find out the code of the Party B corresponding to the information of the target code, furthermore to find out the corresponding personal information of the Party B, thereafter the transceiver sends the message, which the Party C wants to notify the Party B, into the Party B's means of communication.

Preferably, the transceiver comprises a telephone transceiver module and/or an internet transceiver module, to receive and/or send out text information and/or voice information conveniently.

Other aspects and advantages of the present invention will become apparent from the following detailed description, taken in conjunction with the accompanying drawings, illustrating by way of example of the principles of the present invention.

### BRIEF DESCRIPTION OF THE DRAWINGS

FIG. 1 shows the first process of the present invention.

FIG. 2 is a scheme of the communication device capable of ensuring the security of personal information of the present invention.

FIG. 3 shows the second process of the present invention.

### DESCRIPTION OF THE PREFERRED EMBODIMENTS

The present invention provides a communication method and device capable of ensuring the security of personal information, wherein communication between a Party C and a Party B is easy, and at the same time the security of personal information is guaranteed. For explanation, we use a Party A to represent the communication device capable of ensuring the security of personal information, a Party B to represent the main contact person such as a car owner, and a Party C to represent the person who does not specifically have to communicate with Party B.

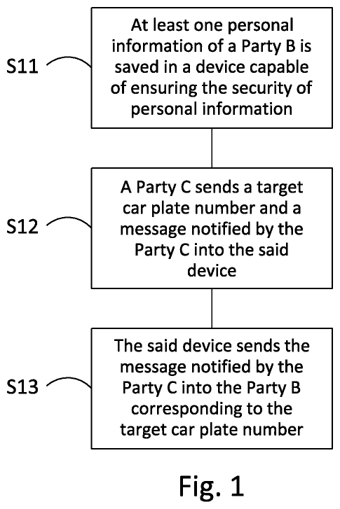

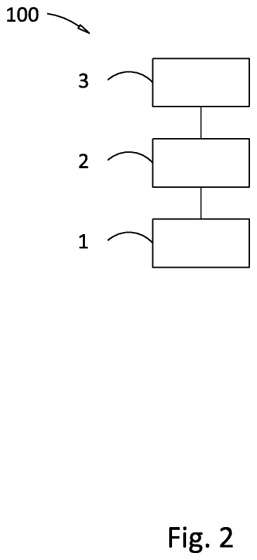

FIG. 1 shows the first process of the present invention. As shown in FIG. 1-2, the a communication method capable of ensuring the security of personal information comprises the following steps: S11: to save at least one personal information of the Party B in a database 1 of a communication device 100 capable of ensuring the security of personal information; wherein the personal information of the Party B includes a Party B's code and a Party B's means of communication, wherein the communication device capable of ensuring the security of personal information 100 comprises furthermore an information processor 2 coupled with the said database 1, and a transceiver 3 coupled with the said information processor 2; S12 the Party C sends an target code and a message, which the Party C wants to notify the Party B, into the transceiver 3; S13: the information processor 2 receives from the transceiver 3 the target code and message, which the Party C wants to notify the Party B, and searches the database 1, according the target code, to find the Party B's code corresponding to the target code, and furthermore to find out the corresponding personal information of the Party B, thereafter the transceiver 3 sends the message, which the Party C wants to notify the Party B, into the Party B's means of communication; thereby communication between the Party C and the Party B is easy, and at the same time the security of personal information is guaranteed. The above points will be explained in detail below.

In the step S11 at least one personal information of the Party B is saved in a database 1 of a communication device capable of ensuring the security of personal information 100; wherein the personal information of the Party B includes a Party B's code and a Party B's means of communication, wherein the communication device capable of ensuring the security of personal information 100 comprises furthermore an information processor 2 coupled with the database 1, and a transceiver 3 coupled with the said processor 2. As the database 1 is created, the personal information of the Party B can be logged in by the Party B himself, or be obtained by other means. The Party B's code is coded by the Party A, or an arbitrary code set by the Party B himself, it can also be such as a car plate number, a customized identifier on an animal collar, a customized identifier on old people's out-of-home bracelet or an identifier for specific purpose. In case the car plate number of the Party B is used as the Party B's code, as an example is explained as following: nowadays the car plate number is public and unique to Party B's information. Therefore, if the Party B's code of the Party B's personal information is set as Part B's car plate number, it is convenient for the Party C to identify the different Party B quickly by the car plate number. Besides, when the transceiver and the Party B's means of communication co-operate, wherein the transceiver sends a message via telephone/or internet, while the Party B uses telephone/or internet as a means of communication to send message, thereby it is convenient to use. In case the Party B uses telephone as means of communication to send message, the Party B's personal information includes furthermore a Party B's telephone number. In case the Party B uses internet as means of communication to send message, the communication device capable of ensuring the security of personal information comprises furthermore a corresponding computer program or APP.

In the step S12 a Party C sends a target code and a message, which the Party wants to notify the Party B, into the transceiver 3. When the Party C wants to communicate the Party B corresponding to the target code, the Party C can send message through the communication device capable of ensuring the security of personal information 100.

In the step S13 the information processor receives from the transceiver the target code and the message, which the Party C wants to notify the Party B, and searches the database, according the target code, to find out the Party B's code corresponding to the information of the target code, and furthermore to find out the corresponding personal information of the Party B, thereafter sends the message, which die Party C wants to notify the Party B, through the transceiver into the Party B's means of communication. Through the predestinated program set within the information processor, message can be automatically searched and forwarded, thereby it is more efficient.

Through the steps S11˜S13, when any Party C wants to communicate with the Party B corresponding to the target code, it is not necessary to obtain Party B's means of communication, like telephone number, the Party C can notify message through the communication device capable of ensuring the security of personal information 100, therewith the Party B cannot get the Party C's means of communication. Thereby it is achieved, that communication between the Party C and the Party B is easy, and at the same time security of personal information is guaranteed, particularly it is guaranteed that the Party B and the Party C cannot know the means of communication of each other. The first process of the present invention realized a means of communication of one-way transmission, wherein the security of personal information is guaranteed, wherein the Party C can notify the Party B in one-way easily; for example, if the Party C sees, that the trunk or fuel tank cap of the driving Party B is open, the Party C can kindly remind the Party B easily.

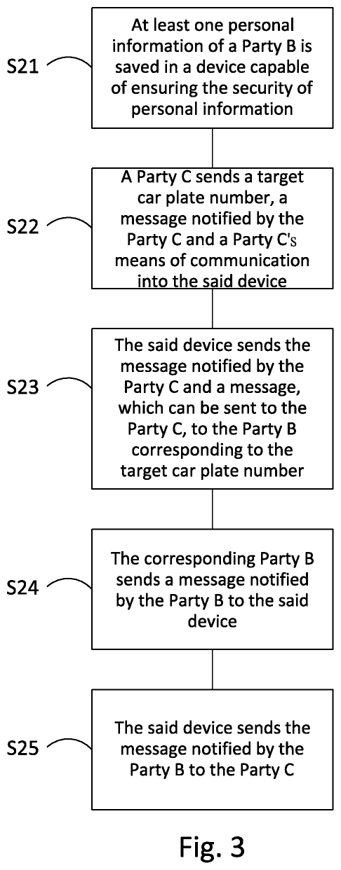

FIG. 3 shows the second process of the present invention. As shown in FIG. 2-3, the present invention of a communication method capable of ensuring the security of personal information comprises the following steps: S21: saving at least one personal information of the Party B in a database of a communication device capable of ensuring the security of personal information, wherein the Party B's personal information includes a Party B's code and a Party B's means of communication; the communication device capable of ensuring the security of personal information comprises furthermore an information processor coupled with the database and a transceiver coupled with the information processor; S22: a Party C sends an target code and a message, which the Party C wants to notify the Party B, into the transceiver, as well as a Party C's means of communication; S23: the information processor receives from the transceiver the target code and the message, which the Party C wants to notify the Party B, and searches the database, according to the target code, to find out the Party B's code corresponding to the target code, and furthermore to find out the corresponding personal information of the Party B, thereafter the transceiver sends the message, which the Party C wants to notify the Party B, to the corresponding means of communication of the Party B, and moreover sends a message to the party C; in this way communication between the Party C and the Party B is easy, and at the same time security of personal information is guaranteed, moreover the Party B can reply message easily. This will be explained in detail below.

In the steps S21˜S23, all the characters of steps S11-S13 mentioned above are included respectively. Besides, in the step S22, the Party C sends a Party C's means of communication into the transceiver, while in the step S23 through the transceiver the message transmitted to the Party C will be sent to the corresponding means of communication of the Party B, thereby it is convenient for the Party B to reply.

After the step S23, there are furthermore following steps: S24: after having received the message, which the Party C wanted to notify the Party B, the corresponding Party B sends a message, which the Party B wants to notify the Party C, into the transceiver; S25: after the information processor has received the message, which the Party B wants to notify the Party C, from the transceiver, the said transceiver sends the message, which the Party B wants to notify the Party C, into the Party C's means of communication; in this way, communication between the Party C and the Party B is easy, and at the same time security of personal information is guaranteed.

The transceiver comprises a telephone transceiver module and/or an internet transceiver module, thereby message can be sent through telephone and/or internet; besides, the message received or sent through the transceiver is/are text and/or voice information. This is explained in an example as follows.

The embodiment 1: in case the transceiver comprises a telephone transceiver module, the Party A gives a Party A's telephone number to the Party B to post, the Party B needs not to make his own telephone number public whereby security of personal information is ensured. Relatively, after any Party C has seen the Party B's code (e.g. Party B's car plate number) and Party A's telephone number, Party B's car plate number is used as the target code and is sent through the Party A, therefore the Party B cannot know the telephone number of the Party C, whereby security of personal information is ensured. Besides, the Party B can choose to receive a text information (in case of telephone transmission that is message), in this case, even the message notified by the Party C via the transceiver to the Party B is a voice information, which can also through the information processor or a conversion module of another device (not shown) be converted into text information, thereafter sent to the Party B.

1. A communication method capable of ensuring the security of personal information comprises the following steps:
S11: at least one personal information of a Party B is saved in a database of a communication device capable of ensuring the security of personal information; wherein the personal information of the Party B includes a Party B's code and a Party B's means of communication; wherein the communication device capable of ensuring the security of personal information comprises an information processor coupled with the database and a transceiver coupled with the information processor;
S12: a Party C sends an target code and a message, which the Party C wants to notify the Party B, into the said transceiver;
S13: the said information processor receives the target code and message, which the Party C wants to notify the Party B, from the transceiver, and searches the database, according to the target code, to find out the Party B's code corresponding to the target code, and furthermore to find out the corresponding personal information of the Party B, thereafter the transceiver sends the message, which the Party C wants to notify the Party B, into the corresponding means of communication of the Party B.

2. A communication method capable of ensuring the security of personal information comprises the following steps:
S21: at least one personal information of a Party B is saved in a database of a communication device capable of ensuring the security of personal information; wherein the personal information of the Party B includes a Party B's code and a Party B's means of communication, wherein the communication device capable of ensuring the security of personal information comprises moreover an information processor coupled with the said database and a transceiver coupled with the said information processor;
S22: a Party C sends a target code and a message, which the Party C wants to notify the Party B, into the transceiver, as well as sends a Party C's means of communication;
S23: the information processor receives the target code and the message, which the Party C wants to notify the Party B, from the transceiver, and searches the database, according to the target code, to find out the Party B's code corresponding to the target code, and furthermore to find out to the corresponding personal information of the Party B, thereafter the transceiver sends the message, which the Party C wants to notify the Party B, into the Party B's means of communication, and moreover sends a message to the Party C.

3. The communication method capable of ensuring the security of personal information of claim 2, comprises furthermore the following steps after the step S23:
S24: having received the message, which the Party C wants to notify the Party B, from the Party C, the corresponding Party B sends a message, which the Party B wants to notify the Party C, into the said transceiver;
S25: the said information processor receives the message, which the Party B wants to notify the Party C, from the transceiver, thereafter the said transceiver sends the message, which the Party B wants to notify the Party C, into the Party C's means communication.

4. The communication method capable of ensuring the security of personal information of claim 1, wherein the transceiver uses telephone and/or internet to send information.

5. The communication method capable of ensuring the security of personal information of claim 2, wherein the transceiver uses telephone and/or internet to send information.

6. The communication method capable of ensuring the security of personal information of claim 3, wherein the transceiver uses telephone and/or internet to send information.

7. The communication method capable of ensuring the security of personal information of claim 4, wherein message received and/or sent through the transceiver is text and/or voice information.

8. The communication method capable of ensuring the security of personal information of claim 5, wherein message received and/or sent through the transceiver is text and/or voice information.

9. The communication method capable of ensuring the security of personal information of claim 6, wherein message received and/or sent through the transceiver is text and/or voice information.

10. The communication method capable of ensuring the security of personal information of claim 4, wherein telephone and/or internet is/are used as the Party B's means of communication to send information.

11. The communication method capable of ensuring the security of personal information of claim 5, wherein telephone and/or internet is/are used as the Party B's means of communication to send information.

12. The communication method capable of ensuring the security of personal information of claim 6, wherein telephone and/or internet is/are used as the Party B's means of communication to send information.

13. The communication method capable of ensuring the security of personal information of claim 1, wherein the Party B's code is the Party B's car plate number.

14. The communication method capable of ensuring the security of personal information of claim 2, wherein the Party B's code is the Party B's car plate number.

15. The communication method capable of ensuring the security of personal information of claim 3, wherein the Party B's code is the Party B's car plate number.

16. A communication device capable of ensuring the security of personal information, comprises:
a database, at least one personal information of a Party B is saved; wherein the Party B's personal information includes a Party B's code and a Party B's means of communication;
an information processor, coupled with the said database; and
a transceiver, coupled with the information processor, for receiving a target code sent by a Party C as well as a message, which the Party C wants to notify the Party B;
wherein the said information processor receives from the transceiver the target code and the message, which the Party C wants to notify the Party B, moreover searches the database, according to the target code, to find out the Party B's code corresponding to the target code and furthermore to find out the corresponding personal information of the Party B, thereafter the transceiver sends the message, which the Party C wants to notify the Party B, to the corresponding means of communication of the Party B.

17. The communication device capable of ensuring the security of personal information of claim 16, wherein the transceiver comprises a telephone transceiver module and/or an internet transceiver module.
